(19) United States
(12) Patent Application Publication
(10) Pub. No.: US 2022/0101465 A1
(43) Pub. Date: Mar. 31, 2022

(54) BLOCKCHAIN SYSTEM, REGISTRATION DEVICE, DEGREE OF CONTRIBUTION COMPUTATION DEVICE, DEGREE OF CONTRIBUTION COMPUTATION METHOD, AND DEGREE OF CONTRIBUTION COMPUTATION PROGRAM

(71) Applicant: Nippon Telegraph and Telephone Corporation, Tokyo (JP)

(72) Inventors: Tatsuro ISHIDA, Musashino-shi, Tokyo (JP); Atsushi Nakadaira, Musashino-shi, Tokyo (JP); Shigeru Fujimura, Musashino-shi, Tokyo (JP); Shigenori Ohashi, Musashino-shi, Tokyo (JP); Hiroki Watanabe, Musashino-shi, Tokyo (JP)

(21) Appl. No.: 17/426,516

(22) PCT Filed: Jan. 16, 2020
(86) PCT No.: PCT/JP2020/001186

§ 371 Date: Jul. 28, 2021

(30) Foreign Application Priority Data
Jan. 30, 2019 (JP) 2019-013868

(51) Int. Cl. G06Q 50/18; G06F 16/27

(52) U.S. Cl. CPC G06Q 50/184; G06Q 2220/18; G06F 16/27

(57) ABSTRACT

A contribution degree of content according to a purchase situation of a content is calculated. A blockchain system includes a registration apparatus 1 and a contribution degree calculation apparatus 2. The registration apparatus 1 includes an acquisition unit 15 configured to acquire content purchase information and a transaction issuance unit 13 configured to issue a transaction including a purchaser ID and a content ID based on the content purchase information. The contribution degree calculation apparatus 2 includes a history acquisition unit 24 configured to acquire history information indicating that a purchaser with the purchaser ID purchases a different type of content associated with the content ID from a distributed ledger in which the transaction is reflected and a contribution degree calculation unit 25 configured to calculate a contribution degree of the content according to a purchase sequence of the content associated with the content ID by using the history information.

### TECHNICAL FIELD

The present invention relates to a technology for calculating a contribution degree of content.

### BACKGROUND ART

In recent years, an intellectual property (IP) such as copyrights are generally used across variable forms of content. For example, a certain IP may be expanded into games and TV animation at the same time, and then expanded into cartoon content. Further, another IP can be expanded into music, and then expanded into content of a novel or a cartoon.

As a mechanism for distributing a profit obtained from sale of content to a content right holder and a content licensee, a technique for distributing a profit according to a predetermined distribution rate via a specific server has been proposed (refer to Patent Literature 1).

### CITATION LIST

### Patent Literature

Patent Literature 1: JP 2002-123635 A

### Non Patent Literature

Non Patent Literature 1: Junichi Kishigami and four others, Introduction to Blockchain Technology, Morikita Publishing (2017), P. 77-85.

### SUMMARY OF THE INVENTION

### Technical Problem

It is assumed that an IP (a) is expanded into a movie, music, a novel, and a play. In a case where a user A likes the novel and starts watching the movie, the novel becomes an entrance to the IP (a) for the user A. In this case, it can be said that the novel contributes to acquisition of the user A for the IP (a). Further, in a case where a user B likes the music and starts watching the movie, the music becomes an entrance to the IP (a) for the user B. In this case, it can be said that the music contributes to acquisition of the user B for the IP (a).

In Patent Literature 1, the distribution rate means distribution according to a predetermined number, and contribution of content as described above is not taken into consideration. That is, in the related art, as in a production committee method, there is only a mechanism for distributing a profit according to an initial investment ratio. As a result, it is difficult to distribute the profit and to adjust an incentive according to contribution of content.

The present invention has been made in view of the above problems, and an object of the present invention is to provide a technique for calculating a contribution degree of content according to a purchase situation of the content.

### Means for Solving the Problem

To achieve the above object, according to an aspect of the present invention, a blockchain system including a registration apparatus and a contribution degree calculation apparatus, the registration apparatus including an acquisition unit configured to acquire content purchase information and a transaction issuance unit configured to issue a transaction including a purchaser ID and a content ID based on the content purchase information; and the contribution degree calculation apparatus including a history acquisition unit configured to acquire history information indicating that a purchaser with the purchaser ID purchases a different type of content associated with the content ID from a distributed ledger in which the transaction is reflected and a contribution degree calculation unit configured to calculate a contribution degree of the content according to a purchase sequence of the content associated with the content ID by using the history information.

According to another aspect of the present invention, a registration apparatus in a blockchain system including the registration apparatus and a contribution degree calculation apparatus, the registration apparatus including: an acquisition unit configured to acquire content purchase information; and a transaction issuance unit configured to issue a transaction including a purchaser ID and a content ID based on the content purchase information.

According to still another aspect of the present invention, a contribution degree calculation apparatus in a blockchain system including a registration apparatus and the contribution degree calculation apparatus, the contribution degree calculation apparatus including: a blockchain control unit configured to reflect a transaction of purchase information including a purchaser ID and a content ID in a distributed ledger of the contribution degree calculation apparatus, the transaction being issued by the registration apparatus; a history acquisition unit configured to acquire history information indicating that a purchaser with the purchaser ID purchases a different type of content associated with the content ID from the distributed ledger; and a contribution degree calculation unit configured to calculate a contribution degree of the content according to a purchase sequence of the content associated with the content ID by using the history information.

According to still further another aspect of the present invention, a contribution degree calculation method of calculating a contribution degree of content by using a blockchain, the method including: at a registration apparatus, acquiring content purchase information, and issuing a transaction including a purchaser ID and a content ID based on the content purchase information, and at a contribution degree calculation apparatus, acquiring history information indicating that a purchaser with the purchaser ID purchases a different type of content associated with the content ID from a distributed ledger in which the transaction is reflected, and calculating a contribution degree of the content according to a purchase sequence of the content associated with the content ID by using the history information.

According to still another aspect of the present invention, a contribution degree calculation program for causing a computer to function as the contribution degree calculation apparatus.

### Effects of the Invention

According to the present invention, it is possible to calculate a contribution degree of content according to a purchase situation of the content.

### BRIEF DESCRIPTION OF DRAWINGS

FIG. 1 is a diagram illustrating an overall configuration of a blockchain system according to an embodiment of the present invention.

FIG. 2 is a diagram illustrating a configuration of a distributed ledger.

FIG. 3 is a diagram illustrating an example of a purchase information token.

FIG. 4 is a sequence diagram illustrating contribution degree calculation processing.

### DESCRIPTION OF EMBODIMENTS

Hereinafter, an embodiment of the present invention will be described with reference to the drawings.

In the present embodiment, a blockchain is used to manage a purchase history of content across services and calculate a contribution degree of a content according to a purchase situation of the content.

The blockchain (refer to Non Patent Literature 1) is a mechanism capable of ensuring reliability without a need for centralized management. In the blockchain, transaction information (transaction) between participants is collected in units of “blocks”, and each block is linked one after another and managed in chronological order. A ledger of a series of pieces of transaction information managed by using the blockchain is referred to as a “distributed ledger”, and each terminal included in a network stores the same distributed ledger.

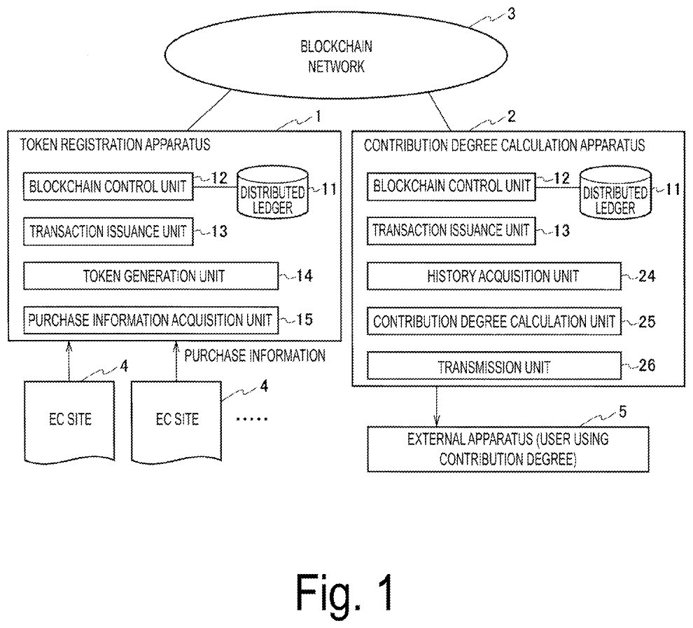

FIG. 1 is a diagram illustrating an overall configuration of a blockchain system according to the present embodiment. The blockchain according to the present embodiment is a smart contract blockchain, and uses Ethereum, which is one of blockchain fundamental technologies. Ethereum is an application development platform for using the blockchain as a distributed ledger that records a state transition. On the other hand, the present invention is not limited to Ethereum, and may be used in blockchains other than Ethereum.

The blockchain system illustrated in FIG. 1 includes a token registration apparatus 1 and a contribution degree calculation apparatus 2. The apparatuses 1 and 2 are autonomously and distributively connected to a blockchain network 3 (hereinafter, referred to as a “network”) which is a P2P network. In addition to the illustrated apparatuses 1 and 2, a plurality of terminals are connected to the network 3. For example, a plurality of token registration apparatuses 1 and a plurality of contribution degree calculation apparatuses 2 may be connected. The apparatuses (terminals) connected to the network 3, each includes a distributed ledger 11, a blockchain control unit 12, and a transaction issuance unit 13, which will be described later, mutually verify data and transactions recorded in the distributed ledger 11, and maintain a system.

The token registration apparatus 1 is an apparatus that registers purchase information of content associated with a predetermined intellectual property (IP) on a blockchain by using a blockchain and a smart contract. The token registration apparatus 1 includes a distributed ledger 11, a blockchain control unit 12, a transaction issuance unit 13, a token generation unit 14, and a purchase information acquisition unit 15.

The distributed ledger 11 stores a latest blockchain almost in real time by loose synchronization with all the terminals connected to the network 3 via the blockchain control unit 12. The distributed ledger 11 according to the present embodiment stores a blockchain and a data set which is managed by the blockchain.

The blockchain control unit 12 maintains the blockchain system in autonomous and distributive cooperation with the terminals connected to the network 3. The blockchain control unit 12 accesses the distributed ledger 11, and reads or updates the blockchain and the data set of the distributed ledger 11. The transaction issuance unit 13 issues a transaction to the network 3.

The purchase information acquisition unit 15 acquires purchase information on content purchased by each purchaser (user) from, for example, an electronic commerce site (EC site) 4. The EC site 4 is a website that sells products such as content on the Internet. The purchase information acquisition unit 15 may acquire purchase information from one EC site 4, or may acquire purchase information from a plurality of EC sites 4.

The token generation unit 14 generates a purchase information token including a purchaser ID and a content ID by using the purchase information of the content acquired by the purchase information acquisition unit 15. In the present embodiment, the transaction issuance unit 13 issues a transaction including the purchase information token.

In the present embodiment, the purchase information token is generated from the purchase information acquired from the EC Site 4. Alternatively, without using a token type, the transaction issuance unit 13 may issue a transaction including a purchaser ID and a content ID based on the purchase information of the content.

The contribution degree calculation apparatus 2 is an apparatus that calculates a contribution degree of content. The illustrated contribution degree calculation apparatus 2 includes a distributed ledger 11, a blockchain control unit 12, a transaction issuance unit 13, a history acquisition unit 24, a contribution degree calculation unit 25, and a transmission unit 26. The distributed ledger 11, the blockchain control unit 12, and the transaction issuance unit 13 of the contribution degree calculation apparatus 2 are the same as the distributed ledger 11, the blockchain control unit 12, and the transaction issuance unit 13 of the token registration apparatus 1.

The history acquisition unit 24 acquires, from the distributed ledger 11 of the contribution degree calculation apparatus 2, history information indicating that a purchaser with the purchaser ID of the transaction issued by the token registration apparatus 1 purchases a different type of content associated with the content ID of the transaction. The history acquisition unit 24 accesses the distributed ledger 11 via the blockchain control unit 12.

The contribution degree calculation unit 25 calculates a contribution degree of content according to a purchase sequence of the content associated with the content ID by using the history information. In addition, the contribution degree calculation unit 25 may determine, by using the contribution degree, a royalty for a right holder on the IP (for example, a copyright) as a source of the content or an incentive for a user who uses the IP.

The transmission unit 26 transmits the contribution degree of each content calculated by the contribution degree calculation unit 25 to an external apparatus 5 that uses the contribution degree. The external apparatus 5 is an apparatus used by, for example, a right holder of the IP as a source of the content or a user who creates and sells content by using the IP.

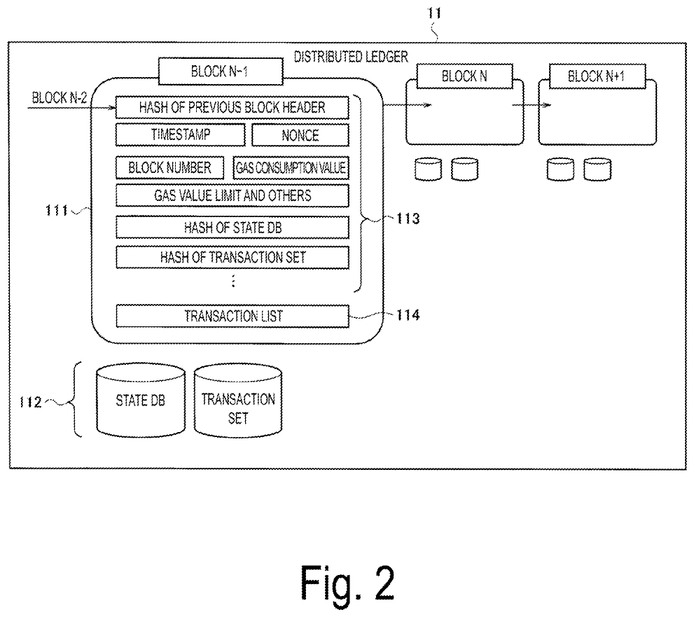

FIG. 2 illustrates a configuration of the distributed ledger 11 of each of the apparatuses 1 and 2. The distributed ledger 11 according to the present embodiment includes a blockchain, which is configured with a plurality of blocks 111, and a data set 112, which is managed corresponding to each block.

The block 111 includes a block header 113, a transaction list 114 and the like. In the block header 113, a summary of the entire distributed ledger 11 at a timing of the block is set. In the illustrated example, in the block header 113, a summary value of the data set 112 is set as a snapshot of the data set 112 at a certain timing. For example, in a case where the data set is stored in a tree structure such as a Merkle tree, a root hash of a Merkle tree is set as a summary value. The transaction list 114 is a list of transactions included in the block 111.

In the illustrated distributed ledger 11, the data set 112 includes a state DB and a transaction set DB. The state DB is a DB for managing a value or a status of a state (variable) of a smart contract at a timing of a certain block. Further, in the state DB, a byte code of the smart contract is stored. In the present embodiment, information is recorded in the state DB in units of data called tokens. Here, the token is a data structure represented by a smart contract.

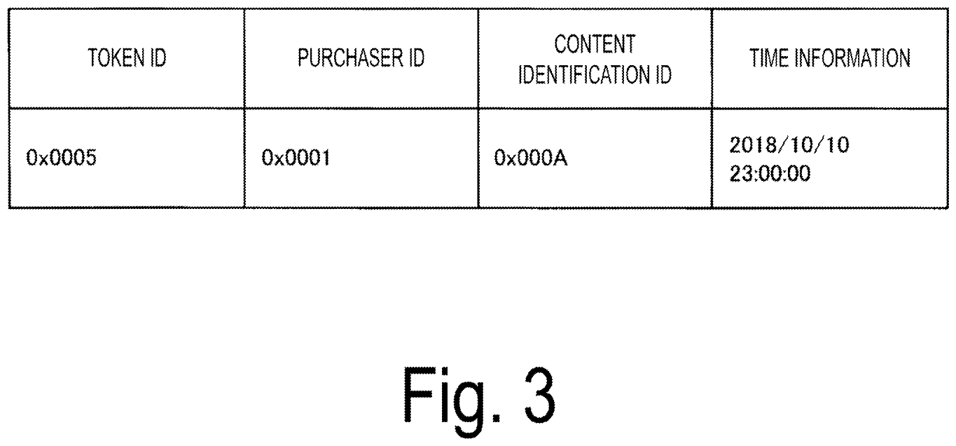

FIG. 3 is a diagram illustrating an example of the purchase information token according to the present embodiment. The illustrated purchase information token is data that includes parameters, such as a token ID, a purchaser ID (purchaser identification information) of the purchaser who purchases the content, a content ID (content identification information), time information and in which the purchase information of the content is managed on the blockchain. That is, in the state DB according to the present embodiment, a value of the state of the smart contract is stored for each token. The content ID is identification information that can uniquely identify IP types (for example, IP (a), IP (b), and the like) and content types (for example, a movie, a novel, music, and the like).

The state DB functions as a key-value store (KVS), and in a case where a search key (for example, a purchaser ID) is input, the value of the state of the token is output.

In Ethereum, in a case where a byte code of a smart contract is registered in the distributed ledger 11 (state DB), identification information indicating the smart contract is assigned. The transaction can be transmitted using the identification information, and thus, the identification information of the smart contract is also called an address. After a transaction is transmitted to an address of a smart contract, the smart contract is executed. The transaction set DB is a DB that indicates sets of the transactions at a timing of a certain block.

Next, processing according to the present embodiment will be described.

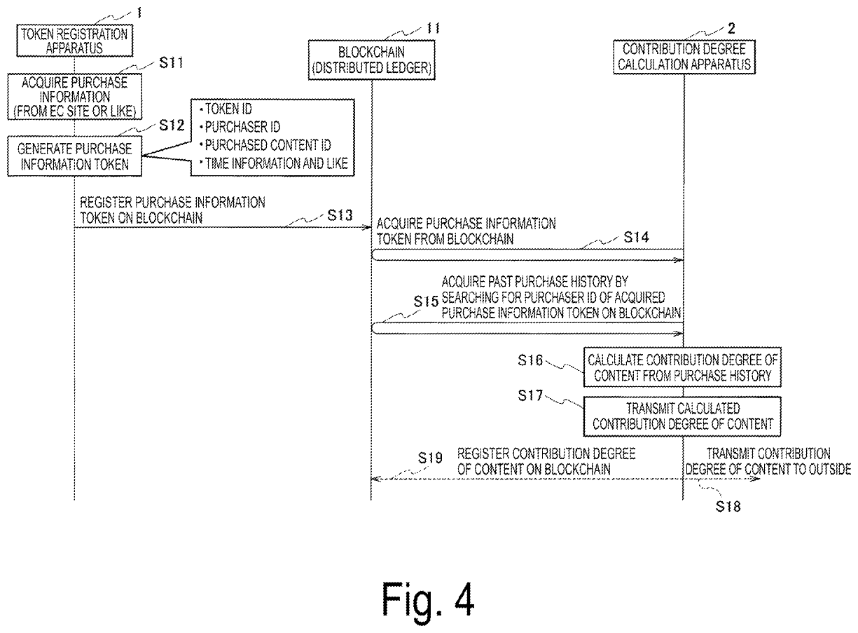

FIG. 4 is a sequence diagram illustrating processing of calculating the contribution degree of content according to the present embodiment.

The token registration apparatus 1 acquires the purchase information of the content from the EC site 4 and the like (step S11). The token registration apparatus 1 generates a purchase information token based on the acquired purchase information (step S12). As illustrated in FIG. 3, the purchase information token includes a token ID, a purchaser ID of a purchaser who purchases the content, a content ID of the purchased content, and time information.

The token registration apparatus 1 registers a transaction including the purchase information token in the blockchain (step S13). Specifically, the token registration apparatus 1 broadcasts the transaction on the network 3. Thereby, the transaction is propagated to all apparatuses connected to the network 3.

Specifically, by loose synchronization between the apparatuses, the block including the transaction transmitted in S11 is reflected in the distributed ledgers 11 of all the apparatuses connected to the network 3. That is, the blockchain control unit 12 of each of all the apparatuses adds the block including the transaction in S11 to the distributed ledger 11 included in the own apparatus. In addition, the blockchain control unit 12 of each of all the apparatuses updates the state DB of the distributed ledger 11 of the own apparatus based on the transaction included in the block.

The distributed ledger 11 (blockchain) illustrated in FIG. 4 indicates the distributed ledger 11 included in each of the apparatuses 1 and 2 connected to the network 3.

The contribution degree calculation apparatus 2 acquires the purchase information token of the transaction issued in S13 from the distributed ledger included in the own apparatus (step S14). It is assumed that the contribution degree calculation apparatus 2 performs contribution degree calculation processing at or after step S14 at any timing. For example, the contribution degree calculation apparatus 2 may calculate the contribution degree every time the purchase information token is registered in the blockchain (for example, each time the content is purchased at the EC site). Further, the contribution degree calculation apparatus 2 may calculate the contribution degree at a timing when the contribution degree of the present time is requested by a person who wants to use the contribution degree (at a timing when the contribution degree calculation apparatus 2 receives a contribution degree calculation request). Further, the contribution degree calculation apparatus 2 may calculate the contribution degree on a regular basis (for example, once daily).

The contribution degree calculation apparatus 2 acquires a past purchase history of the purchaser ID (purchaser), which is set in the purchase information token acquired in step S14, from the distributed ledger 11 of the own apparatus (state DB) (step S15). The apparatuses 1 and 2 (nodes) for the blockchain that are connected to the network 3 store the distributed ledgers 11 synchronized between the apparatuses 1 and 2. Thus, the contribution degree calculation apparatus 2 can easily search for the purchase history of the content of the purchaser ID from the distributed ledger 11 included in the own apparatus without passing through the network 3.

For example, the contribution degree calculation apparatus 2 acquires the purchase information token (past purchase history) of the purchaser ID from the distributed ledger 11 by searching for the distributed ledger 11 included in the own apparatus by using, as a search key, the purchaser ID of the purchase information token acquired in step S14. The searching method is not limited to the method described above, and any searching method may be used.

In a case where the purchaser has a history of purchasing the content associated with the content ID in the past, the contribution degree calculation apparatus 2 calculates a contribution degree of the content (step S16). The content associated with the content ID is a different type of content, which is expanded from the IP as a source of the content indicated by the content ID. For example, in a case where the content indicated by the content ID is content obtained by expanding an IP (a) into a movie, the content associated with the content ID is content obtained by expanding the IP (a) into a novel, music, or the like.

In the following, calculation of the contribution degree using the purchase history will be specifically described. That is, the contribution degree calculation apparatus 2 calculates the contribution degree of content according to a purchase sequence of the content associated with the content ID by using the history information.

Here, a case where an IP (b) is expanded into four contents of a novel, a movie, music, and a cartoon will be described as an example. Further, the contribution degree calculation apparatus 2 specifies an order (timing) in which the purchaser purchases the content associated with the IP (b) by using the time information of the purchase information token.

In a case where a user A reads a novel of the IP (b) and then watches a movie of the IP (b), it is assumed that the novel is content1 (c1) and a contribution rate of the novel is +m. “m” is any positive natural number indicating a contribution value according to purchase of content.

In the present embodiment, it is assumed that m is multiplied by a coefficient (weight) according to a type of content in consideration of market sizes of content such as a novel, a movie, and music and circumstances such as preset contracts. Here, it is assumed that coefficients of a novel, a movie, and music are a, b, and c. Without considering the above circumstances, a, b, and c may all be “1”.

Next, in a case where the user A purchases the music, contribution values of the novel and the movie are set as follows.
Contribution value of novel (c1): +(a*m)
Contribution value of movie (c2): +(b*m)
   At this time, the contribution degree of the novel to sales of all the contents expanded from the IP (b) is 2*(a*m)/(2*(a*m)+(b*m)). Here, the novel is an entrance to the IP (b) for the user A, and thus the contribution degree of the novel is multiplied by a predetermined coefficient (here, “2”) such that the contribution degree of the novel is larger than the contribution degree of the movie.

As the types of the content increase, the earliest (oldest) released content will have a higher contribution degree. On the other hand, some later content may have a high contribution degree to the overall sales of the IP. Thus, considering an actual situation, the following mechanism is required.
Decrease contribution degree of initially-purchased content over time
Calculate contribution degree only for X types of most recently (latest) purchased content

In the following, an example of calculating the contribution degree only for X types of the latest content will be described. Here, it is assumed that X is 2.

It is assumed that the user A purchases a novel, a movie, music, and a cartoon in this order from a plurality of types of the content of the IP (b). In this case, at a timing when the user A purchases the cartoon, the contribution degree of each content is calculated as follows.
Contribution degree of novel: not calculated because novel is old content (because novel does not correspond to two types of content)
Contribution degree of movie: (3*(b*m)/(3*(b*m)+2*(c*m)))
Contribution degree of music: (2*(c*m)/(3*(b*m)+2*(c*m)))
Contribution degree of cartoon: contribution degree is not calculated due to purchase of cartoon at present timing
   Here, from the viewpoint of ensuring that older content has a higher contribution degree, a relatively-large predetermined coefficient (3) is set for the content (movie) of which the purchase timing is older, and a coefficient (2) smaller than the predetermined coefficient is set for the content (music) of which the purchase timing is later. That is, the coefficient is set according to the purchase timing (order).

Next, a case where X is 3 will be described.

It is assumed that an IP (c) includes contents such as a novel, a movie, music, a cartoon, and an illustration collection. It is assumed that a user B initially purchases the novel. The contribution degree calculation apparatus 2 does not calculate the contribution degree of the novel at the time of the initial purchase of the novel (content).

Next, it is assumed that the user B purchases the movie. The reason why the user B purchases the movie is because the novel is interesting. Thus, the contribution degree calculation apparatus 2 considers that the user B is attracted to the IP (c) by the novel, and calculates the contribution degree of the novel. At the timing, the contribution degree of the novel is 100%.
Contribution degree of novel: ((a*m)/(a*m))
Contribution degree of movie: contribution degree is not calculated when movie is purchased. Next, it is assumed that the user B purchases the music. In this case, from the viewpoint of highly evaluating the content with an older purchase timing, the novel is multiplied by a coefficient of 2. The contribution degree of each content is calculated as follows.
Contribution degree of novel: (2*(a*m)/2*(a*m)+(b*m))
Contribution degree of movie: ((b*m)/(2*(a*m)+(b*m)))
Contribution degree of movie: contribution degree of music is not calculated when music is purchased.

Next, it is assumed that the user B purchases the cartoon. From the viewpoint of highly evaluating the content with an older purchase timing, the novel is multiplied by a coefficient of 3. Further, the movie is multiplied by 2. The contribution degree of each content is calculated as follows.
Contribution degree of novel: (3*(a*m)/(3*(a*m)+2*(b*m)+(c*m)))
Contribution degree of movie: (2*(b*m)/(3*(a*m)+2*(b*m)+(c*m)))
Ratio of Contribution degree of music: ((c*m)/(3*(a*m)+2*(b*m)+(c*m)))
Ratio of Contribution degree of cartoon: contribution degree of cartoon is not calculated when cartoon is purchased.

Next, it is assumed that the user B purchases the illustration collection. The purchase of the content that is too old is excluded from the contribution degree evaluation. On the other hand, in a range in which X is 3, from the viewpoint of highly evaluating the content with an older purchase timing, the movie is multiplied by a coefficient of 3. Further, the music is multiplied by 2. The contribution degree of each content is calculated as follows.
Contribution degree of novel: excluded from calculation because purchase is too old
Contribution degree of movie: (3*(a*m)/(3*(a*m)+2*(b*m)+(c*m)))
Contribution degree of music: (2*(b*m)/(3*(a*m)+2*(b*m)+(c*m)))
Contribution degree of cartoon: ((c*m)/(3*(a*m)+2*(b*m)+(c*m)))
Contribution degree of illustration collection: contribution degree of illustration collection is not calculated when illustration collection is purchased
   As described above, the contribution degree calculation apparatus 2 calculates the contribution degree of each content, which is purchased by one user, to the predetermined IP corresponding to the content ID which is set in the transaction.

The contribution degree calculation apparatus 2 calculates the contribution degree of each content, which is purchased by each of n persons for which the purchase information token is registered in the blockchain (distributed ledger 11), to the predetermined IP, calculates an average value of the contribution degrees by the n persons, and sets the average value as the contribution degree of each content. From the content ID of the purchase information token, it is possible to recognize to which IP, the content is associated (corresponds).

The contribution degree calculation apparatus 2 transmits the calculated contribution degree of each content to the predetermined IP (step S17). Thereby, the contribution degree calculation apparatus 2 feed-backs the contribution degree of the content to the IP right holder and the user. Specifically, the contribution degree calculation apparatus 2 may transmit the calculated contribution degree of the content to the external apparatus 5 (step S18). The external apparatus 5 is an apparatus used by an IP right holder, a user who creates and sells content by using the IP and the like. Further, in a case where the apparatus used by the IP right holder and the user is a node connected to the blockchain network 3, the contribution degree calculation apparatus 2 may issue a transaction including the calculated contribution degree, and register the contribution degree in the blockchain (S19).

The IP right holder and the user can use the contribution degree calculated by the contribution degree calculation apparatus 2 to determine a royalty on the IP or an incentive. Specifically, an incentive may be designed for the content with a high contribution degree. When using a specific content, an IP user generally pays a royalty to an IP right holder. Examples of an incentive using the royalty will be described.

Pattern 1

In Pattern 1, a discount is applied in a case where the contribution degree is equal to or higher than a certain level. For example, a fixed discount rate is applied in order from the content with a highest contribution degree. It is assumed that an IP is released in order of a novel, an animation, and a cartoon and a user purchases the contents in the same order. In this case, when the user purchases the cartoon, it is assumed that the contribution degree of the novel is higher than the contribution degree of the animation. In this case, a discount rate of 10% is applied to the novel, and a discount rate of 7% is applied to the animation.

Further, in a case where the average contribution degree is equal to or higher than a predetermined threshold value, a predetermined discount rate may be uniformly applied to the royalties which are preset for each content.

Pattern 2

There is a production committee method as a method of creating contents associated with a predetermined IP. In the production committee method, generally, a plurality of companies gather and each invests, sells a predetermined IP using various types and forms of content, and distribute a sales profit according to investment ratios.

The distribution according to the investment ratio can be multiplied by a certain ratio according to the calculated contribution degree, and it is possible to use this as an incentive. It is considered that the certain ratio is set in advance by agreement as in Pattern 1.

The contribution degree calculation unit 25 of the contribution degree calculation apparatus 2 may calculate the royalty or the incentive, and transmit the calculated royalty or incentive (step S17 to step S18). That is, the contribution degree calculation unit 25 of the contribution degree calculation apparatus 2 may determine, based on the calculated contribution degree, a royalty to the right holder of the IP as a source of the content, or an incentive for the user who uses the IP.

In the present embodiment described above, the token registration apparatus 1 includes the purchase information acquisition unit 15 that acquires content purchase information and the transaction issuance unit 13 that issues a transaction including a purchaser ID and a content ID based on the content purchase information. The contribution degree calculation apparatus 2 includes the history acquisition unit 24 that acquires, from the distributed ledger 11 in which the transaction is reflected, history information indicating that a purchaser with the purchaser ID purchases a different type of content associated with the content ID and the contribution degree calculation unit 25 that calculates a contribution degree of a content according to a purchase sequence of the content associated with the content ID by using the history information.

Thereby, in the present embodiment, the contribution degree of content according to the purchase sequence of the content can be calculated across services. Specifically, for contents associated with a predetermined IP, there is a user (purchaser) who actually purchases (consumes) the content before a user who uses the IP. There are various entrances through which the user begins to purchase contents. For example, in an IP from which various contents such as a movie, music, a novel, and a play are expanded, in a case where the user A likes the novel and starts to watch the movie, the novel becomes an entrance to the IP for the user A. In this case, it can be said that the novel contributes to acquisition of the user A for the IP. In the present embodiment, by using the blockchain, it is possible to track contribution of the content and calculate the contribution degree of the content in consideration of a relationship between the contents. Thereby, it is possible to easily adjust an incentive including distribution of a profit according to the contribution degree.

Further, in the present embodiment, the token registration apparatus 1 collects the pieces of content purchase information corresponding to a purchase act of a user, and registers the pieces of content purchase information on the blockchain. Thereby, it is possible to comprehensively manage acts of a user who purchases different media (types) of content. That is, in the present embodiment, by registering, on the blockchain, the purchase history of the content across services and calculating the contribution degree of the content from the purchase history, it is possible to return a profit according to contribution between content users. Thus, it is possible to promote healthy competition among the contents and promote use of the content.

Further, in the present embodiment, it is possible to calculate the content that contributes to the sales of the entire IP from a content group of the predetermined IP, and thus it is possible to give an incentive to a user of the IP. By using the present embodiment, it is possible to accurately recognize a content use situation of the right. Thus, by using the legal right in secondary use and tertiary use, a financial incentive is given to the right holder.

Further, in the present embodiment, by using a blockchain and a smart contract having high tamper resistance, it becomes extremely difficult to make a false declaration.

As the token registration apparatus 1 and the contribution degree calculation apparatus 2, for example, a general-purpose computer system including a central processing unit (CPU, a processor), a memory, a storage such as hard disk drive (HDD) or a solid state drive (SSD), a communication device, an input device, and an output device may be used. In the computer system, the CPU executes a predetermined program loaded into the memory, and thus each function of each apparatus is realized. For example, each function of the token registration apparatus 1 and the contribution degree calculation apparatus 2 is realized by executing the program for the token registration apparatus 1 by the CPU of the token registration apparatus 1 and executing the program for the contribution degree calculation apparatus 2 by the CPU of the contribution degree calculation apparatus 2.

Further, the program for the token registration apparatus 1 and the program for the contribution degree calculation apparatus 2 may be stored in a computer-readable recording medium such as an HDD, an SSD, a USB memory, a CD-ROM, a DVD-ROM, or an MO, and may also be distributed through a network.

The present invention is not limited to the embodiment, and various modifications can be made within the scope of the gist of the present invention. For example, in the embodiment, the contribution degree calculation apparatus 2 is a blockchain node connected to the blockchain network 3, but the contribution degree calculation apparatus 2 may not be a blockchain node. In this case, the contribution degree calculation apparatus 2 may transmit a request to the blockchain node, and the blockchain node may acquire the purchase information token and the purchase history of the purchaser from the distributed ledger 11 of the blockchain node and transmit the purchase information token and the purchase history of the purchaser to the contribution degree calculation apparatus 2.

### REFERENCE SIGNS LIST

1: Token registration apparatus
2: Contribution degree calculation apparatus
11: Distributed ledger
12: Blockchain control unit
13: Transaction issuance unit
14: Token generation unit
15: Purchase information acquisition unit
24: History acquisition unit
25: Contribution degree calculation unit
26: Transmission unit
3: Blockchain network
4: EC site
5: External apparatus

1. A blockchain system comprising: a registration apparatus; and a contribution degree calculation apparatus, wherein
the registration apparatus, including one or more processors, includes
an acquisition unit, including one or more processors, configured to acquire content purchase information, and
a transaction issuance unit, including one or more processors, configured to issue a transaction including a purchaser ID and a content ID based on the content purchase information; and
the contribution degree calculation apparatus, including one or more processors, includes
a history acquisition unit, including one or more processors configured to acquire, from a distributed ledger in which the transaction is reflected, history information indicating that a purchaser with the purchaser ID purchases a different type of content associated with the content ID, and
a contribution degree calculation unit, including one or more processors, configured to calculate a contribution degree of the content according to a purchase sequence of the content associated with the content ID by using the history information.

2. The blockchain system according to claim 1, wherein
the registration apparatus, including one or more processors, includes a token generation unit, including one or more processors, configured to generate a purchase information token including the purchaser ID and the content ID by using the content purchase information, and
the transaction issuance unit, including one or more processors, issues the transaction including the purchase information token.

3. The blockchain system according to claim 1, wherein
the contribution degree calculation unit, including one or more processors, determines a royalty for a right holder of an intellectual property (IP) as a source of the content, or an incentive for a user who uses the IP, by using the contribution degree.

4. (canceled)

5. A contribution degree calculation apparatus in a blockchain system including a registration apparatus and the contribution degree calculation apparatus, the contribution degree calculation apparatus, including one or more processors, comprising:
a blockchain control unit, including one or more processors, configured to reflect a transaction of purchase information including a purchaser ID and a content ID in a distributed ledger of the contribution degree calculation apparatus, the transaction being issued by the registration apparatus;
a history acquisition unit, including one or more processors, configured to acquire, from the distributed ledger, history information indicating that a purchaser with the purchaser ID purchases a different type of content associated with the content ID; and
a contribution degree calculation unit, including one or more processors, configured to calculate a contribution degree of the content according to a purchase sequence of the content associated with the content ID by using the history information.

6. A contribution degree calculation method of calculating a contribution degree of content by using a blockchain, the method comprising:
at a registration apparatus,
acquiring content purchase information, and
issuing a transaction including a purchaser ID and a content ID based on the content purchase information, and
at a contribution degree calculation apparatus,
acquiring, from a distributed ledger in which the transaction is reflected, history information indicating that a purchaser with the purchaser ID purchases a different type of content associated with the content ID, and
calculating a contribution degree of the content according to a purchase sequence of the content associated with the content ID by using the history information.

7. (canceled)
